(19) United States
(12) Patent Application Publication
(10) Pub. No.: US 2011/0020107 A1
(43) Pub. Date: Jan. 27, 2011

(54) MOLDED WIND TURBINE SHROUD SEGMENTS AND CONSTRUCTIONS FOR SHROUDS

(75) Inventors: Walter M. Presz, JR., Wilbraham, MA (US); Michael J. Werle, West Hartford, CT (US); Thomas J. Kennedy, III, Wilbraham, MA (US); William Scott Keeley, Charleston, RI (US); Robert Dold, Monson, MA (US)

Correspondence Address: FAY SHARPE LLP, 1228 Euclid Avenue, 5th Floor, The Halle Building, Cleveland, OH, 44115, US

(73) Assignee: FLODESIGN WIND TURBINE CORPORATION, Wilbraham, MA (US)

(21) Appl. No.: 12/793,430

(22) Filed: Jun. 3, 2010

Related U.S. Application Data
(63) Continuation-in-part of application No. 12/054,050, filed on Mar. 24, 2008.
(60) Provisional application No. 61/183,580, filed on Jun. 3, 2009.
(60) Provisional application No. 60/919,588, filed on Mar. 23, 2007.

(51) Int. Cl. F03B 15/06; B29C 41/02; B29C 41/06

(52) U.S. Cl. 415/4.1; 264/299; 264/310; 264/573

(57) ABSTRACT

A wind turbine shroud that comprises a plurality of wind turbine shroud segments engaged to each other in a radial pattern about a central axis. Each wind turbine shroud segment may be created through a rotational molding and/or blow molding process and can be engaged with other wind turbine shroud segments to create a variety of wind turbine shrouds.

This application claims priority to U.S. Provisional Patent Application Ser. No. 61/183,580, filed Jun. 3, 2009. This application is also a continuation-in-part from U.S. patent application Ser. No. 12/054,050, filed Mar. 24, 2008, which claimed priority from U.S. Provisional Patent Application Ser. No. 60/919,588, filed Mar. 23, 2007. The disclosure of these applications is hereby fully incorporated by reference in their entirety.

### BACKGROUND

The present disclosure relates to wind turbines, particularly shrouded wind turbines. The shroud is formed from a plurality of shroud segments that engage each other.

Conventional wind turbines used for power generation generally have two to five open blades arranged like a propeller, the blades being mounted to a horizontal shaft attached to a gear box which drives a power generator. Such turbines are generally known as horizontal axis wind turbines, or HAWTs. These turbines typically require a supporting tower ranging from 60 to 90 meters in height. The blades generally rotate at a rotational speed of about 10 to 22 rpm. A gear box is commonly used to step up the speed to drive the generator, although some designs may directly drive an annular electric generator. Although HAWTs have achieved widespread usage, their efficiency is not optimized. In particular, they will not exceed the Betz limit of 59.3% efficiency in capturing the potential energy of the wind passing through it.

Several problems are associated with HAWTs in both construction and operation. The tall towers and long blades are difficult to transport. Massive tower construction is required to support the heavy blades, gearbox, and generator. Very tall and expensive cranes and skilled operators are needed for installation. In operation, HAWTs require an additional yaw control mechanism to turn the blades toward the wind. HAWTs typically have a high angle of attack on their airfoils that do not lend themselves to variable changes in wind flow. HAWTs are difficult to operate in near ground, turbulent winds. Ice build-up on the nacelle and the blades can cause power reduction and safety issues. Tall HAWTs may affect airport radar. Their height also makes them obtrusively visible across large areas, disrupting the appearance of the landscape and sometimes creating local opposition. Finally, downwind variants suffer from fatigue and structural failure caused by turbulence. It would be desirable to provide a wind turbine that can avoid these problems.

### BRIEF DESCRIPTION

Disclosed herein are shrouded wind turbines and methods and apparatuses for constructing the shrouds used in such turbines. In particular, wind turbine shroud segments are assembled about a central axis to form the wind turbine shroud.

Disclosed in embodiments is a wind turbine shroud segment, comprising a front edge, a rear edge, an interior face, an exterior face, a first lateral face, and a second lateral face. The front edge has a first end and a second end. The rear edge comprises a first outer edge, a second outer edge, an inner edge, a first radial edge, and a second radial edge. The first outer edge and the second outer edge are located in an outer plane. The inner edge is located in an inner plane and between the first and second outer edges. The first radial edge extends from a first end of the inner edge to an interior end of the first outer edge. The second radial edge extends from a second end of the inner edge to an interior end of the second outer edge. The interior face extends from the front edge to the rear edge. The exterior face extends from the front edge to the rear edge. The first lateral face extends from an exterior end of the first outer edge to the first end of the front edge. The second lateral face extends from an exterior end of the second outer edge to the second end of the front edge.

In some embodiments, the front edge has an arcuate shape. In others described herein, the front edge is used to connect the shroud segment to another structural member in the shroud. The first lateral face and the second lateral face may each have an airfoil shape.

In some embodiments, the first outer edge and the second outer edge have a common outer radius of curvature, the inner edge has an inner radius of curvature, and the front edge has a front radius of curvature. The front radius of curvature is less than the outer radius of curvature, and the inner radius of curvature is less than the outer radius of curvature.

The wind turbine shroud segment is hollow in particular embodiments.

The first lateral face of the wind turbine shroud segment may comprise a protrusion and the second lateral face of the wind turbine shroud segment may comprise a cavity, the protrusion and the cavity being substantially complementary in shape so that adjacent shroud segments can engage each other. Sometimes, the protrusion and the cavity are shaped so that adjacent shroud segments engage each other in a lateral direction. In other embodiments, the protrusion and the cavity are shaped so that adjacent shroud segments engage each other in a radial direction.

The wind turbine shroud segment may further comprise a support member extending radially from the exterior face.

Also disclosed herein are methods for making a wind turbine shroud segment, comprising: placing a molten plastic material in a mold; conforming the molten plastic material to the mold to create a segment shape; cooling the segment shape; and removing the segment shape from the mold to obtain the shroud segment. The shroud segment has a shape as described above and herein.

The plastic material may be conformed to the mold by rotating the mold biaxially. In other embodiments, the plastic material is conformed to the mold by injecting compressed air into the molten plastic material to form a hollow interior space within the molten plastic material.

The plastic material can be a polymer, such as a polyolefin or a polyamide.

Also disclosed is wind turbine shroud comprising a plurality of wind turbine shroud segments, wherein adjacent wind turbine shroud segments are engaged to each other in a radial pattern about a central axis. The wind turbine shroud segments have a shape as described above and herein.

In some embodiments, the wind turbine shroud further comprises a ring member surrounding the wind turbine shroud segments. In other embodiments, the wind turbine shroud further comprises a rigid structural member, the front edge of each shroud segment connecting to the rigid structural member.

In other embodiments, the plurality of shroud segments used to form the wind turbine shrouds includes a first set of shroud segments and a second set of shroud segments. The first set of shroud segments further comprises a support member extending vertically from the exterior face of each shroud segment. The second set of shroud segments does not have a support member.

### BRIEF DESCRIPTION OF THE DRAWINGS

The following is a brief description of the drawings, which are presented for the purposes of illustrating the disclosure set forth herein and not for the purposes of limiting the same.

FIG. 1 is an exploded view of a first exemplary embodiment or version of a MEWT of the present disclosure.

FIG. 2 is a front perspective view of FIG. 1 attached to a support tower.

FIG. 3 is a front perspective view of a second exemplary embodiment of a MEWT, shown with a shrouded three bladed impeller.

FIG. 4 is a rear view of the MEWT of FIG. 3.

FIG. 5 is a cross-sectional view taken along line 5-5 of FIG. 4.

FIG. 6 is a perspective view of another exemplary embodiment of a wind turbine of the present disclosure having a pair of wing-tabs for wind alignment.

FIG. 7 is a front perspective view of another exemplary embodiment of a MEWT of the present disclosure. Here, both the turbine shroud and the ejector shroud have mixing lobes on their trailing edges.

FIG. 8 is a rear perspective view of the MEWT of FIG. 7.

FIG. 9 is a front perspective view of another exemplary embodiment of a MEWT according to the present disclosure.

FIG. 10 is a side cross-sectional view of the MEWT of FIG. 9 taken through the turbine axis.

FIG. 11 is a smaller view of FIG. 10.

FIG. 11A and FIG. 11B are magnified views of the mixing lobes of the MEWT of FIG. 9.

FIG. 12 is a front perspective view of an exemplary embodiment of a wind turbine shroud segment according to the present disclosure.

FIG. 13 is a rear perspective view of the shroud segment of FIG. 12.

FIG. 14 is a front perspective view of an exemplary embodiment of a wind turbine shroud segment having a support member according to the present disclosure.

FIG. 15 is a rear perspective view of the shroud segment of FIG. 14.

FIG. 16 is a front perspective view of another exemplary embodiment of a wind turbine shroud segment according to the present disclosure, having a different joining mechanism.

FIG. 17 is a rear perspective view of the shroud segment of FIG. 16.

FIG. 18 is a front perspective view of another exemplary embodiment of a wind turbine shroud segment like FIG. 16, but having a support member.

FIG. 19 is a rear perspective view of the shroud segment of FIG. 18.

FIG. 20 shows a wind turbine in exploded view. The wind turbine has a turbine shroud and an ejector shroud, both being formed from wind turbine shroud segments.

FIG. 21 is a perspective view of the wind turbine of FIG. 20 in an assembled state.

FIG. 22 is a rear view of the ejector shroud of FIG. 20, showing additional aspects of the wind turbine shroud segments.

FIG. 23 is an exploded perspective view of a wind turbine shroud prior to assembly. The shroud includes a plurality of wind turbine shroud segments and a ring member surrounding the shroud segments.

FIG. 24 is a perspective view of the wind turbine of FIG. 23 in an assembled state.

FIG. 25 is a perspective view of an exemplary shrouded wind turbine. The wind turbine includes a turbine shroud and an ejector shroud. The turbine shroud includes a plurality of wind turbine shroud segments connected to a first rigid structural member that forms the leading edge of the turbine shroud. A first set of wind turbine shroud segments comprises a support member. A second set of wind turbine shroud segments does not comprise a support member.

### DETAILED DESCRIPTION

A more complete understanding of the components, processes, and apparatuses disclosed herein can be obtained by reference to the accompanying figures. These figures are merely schematic representations based on convenience and the ease of demonstrating the present development and are, therefore, not intended to indicate the relative size and dimensions of the devices or components thereof and/or to define or limit the scope of the exemplary embodiments.

Although specific terms are used in the following description for the sake of clarity, these terms are intended to refer only to the particular structure of the embodiments selected for illustration in the drawings and are not intended to define or limit the scope of the disclosure. In the drawings and the following description below, it is to be understood that like numeric designations refer to components of like function.

The modifier “about” used in connection with a quantity is inclusive of the stated value and has the meaning dictated by the context (for example, it includes at least the degree of error associated with the measurement of the particular quantity). When used in the context of a range, the modifier “about” should also be considered as disclosing the range defined by the absolute values of the two endpoints. For example, the range “from about 2 to about 4” also discloses the range “from 2 to 4.”

A Mixer-Ejector Power System (MEPS) provides a unique and improved means of generating power from wind currents. A MEPS includes:
a primary shroud containing a turbine or bladed impeller, similar to a propeller, which extracts power from the primary stream; and
a single or multiple-stage mixer-ejector to ingest flow with each such mixer/ejector stage including a mixing duct for both bringing in secondary flow and providing flow mixing-length for the ejector stage. The inlet contours of the mixing duct or shroud are designed to minimize flow losses while providing the pressure forces necessary for good ejector performance.

The resulting mixer/ejectors enhance the operational characteristics of the power system by: (a) increasing the amount of flow through the system, (b) reducing the exit or back pressure on the turbine blades, and (c) reducing the noise propagating from the system.

The MEPS may include:
camber to the duct profiles to enhance the amount of flow into and through the system;
acoustical treatment in the primary and mixing ducts for noise abatement flow guide vanes in the primary duct for control of flow swirl and/or mixer-lobes tailored to diminish flow swirl effects;
turbine-like blade aerodynamics designs based on the new theoretical power limits to develop families of short, structurally robust configurations which may have multiple and/or counter-rotating rows of blades;
exit diffusers or nozzles on the mixing duct to further improve performance of the overall system;
inlet and outlet areas that are non-circular in cross section to accommodate installation limitations;
a swivel joint on its lower outer surface for mounting on a vertical stand/pylon allowing for turning the system into the wind;
vertical aerodynamic stabilizer vanes mounted on the exterior of the ducts with tabs or vanes to keep the system pointed into the wind; or
mixer lobes on a single stage of a multi-stage ejector system.

Referring to the drawings in detail, the figures illustrate alternate embodiments of Applicants' axial flow Wind Turbine with Mixers and Ejectors (“MEWT”).

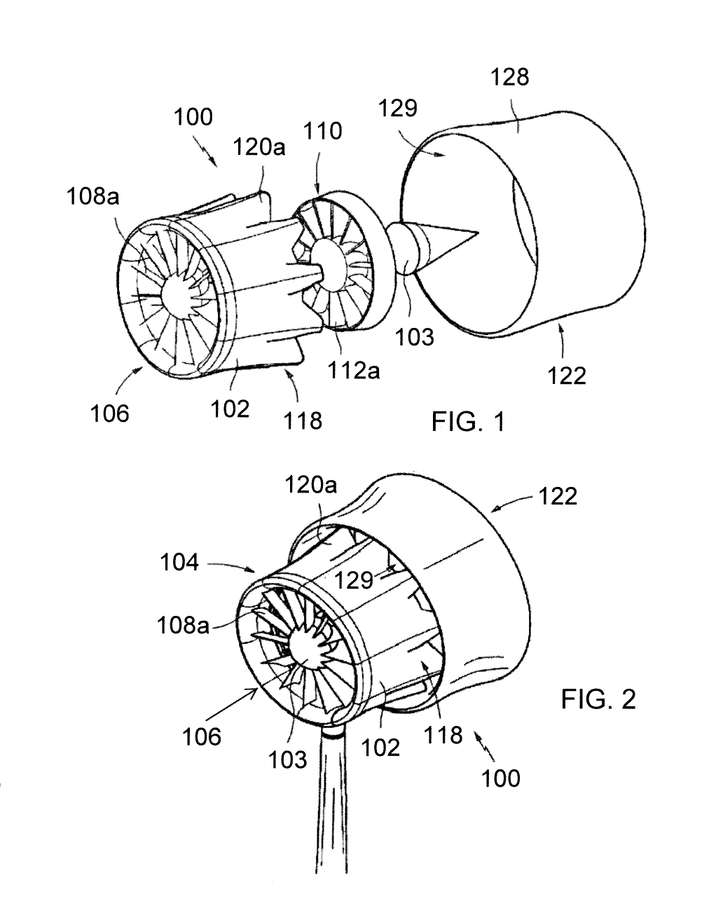

Referring to FIG. 1 and FIG. 2, the MEWT 100 is an axial flow turbine with:

a) an aerodynamically contoured turbine shroud 102;

b) an aerodynamically contoured center body 103 within and attached to the turbine shroud 102;

c) a turbine stage 104, surrounding the center body 103, comprising a stator ring 106 having stator vanes 108a and a rotor 110 having rotor blades 112a. Rotor 110 is downstream and “in-line” with the stator vanes, i.e., the leading edges of the impeller blades are substantially aligned with trailing edges of the stator vanes, in which:
i) the stator vanes 108a are mounted on the center body 103;
ii) the rotor blades 112a are attached and held together by inner and outer rings or hoops mounted on the center body 103;

d) a mixer indicated generally at 118 having a ring of mixer lobes 120a on a terminus region (i.e., end portion) of the turbine shroud 102, wherein the mixer lobes 120a extend downstream beyond the rotor blades 112a; and,

e) an ejector indicated generally at 122 comprising an ejector shroud 128, surrounding the ring of mixer lobes 120a on the turbine shroud, wherein the mixer lobes (e.g., 120a) extend downstream and into an inlet 129 of the ejector shroud 128.

The center body 103 of MEWT 100, as shown in FIG. 2, is desirably connected to the turbine shroud 102 through the stator ring 106, or other means. This construction serves to eliminate the damaging, annoying and long distance propagating low-frequency sound produced by traditional wind turbines as the wake from the turbine blades strike the support tower. The aerodynamic profiles of the turbine shroud 102 and ejector shroud 128 are aerodynamically cambered to increase flow through the turbine rotor.

Applicants have calculated, for optimum efficiency, the area ratio of the ejector pump 122, as defined by the ejector shroud 128 exit area over the turbine shroud 102 exit area, will be in the range of 1.5-3.0. The number of mixer lobes 120a would be between 6 and 14. Each lobe will have inner and outer trailing edge angles between 5 and 65 degrees. These angles are measured from a tangent line that is drawn at the exit of the mixing lobe down to a line that is parallel to the center axis of the turbine, as will be explained further herein. The primary lobe exit location will be at, or near, the entrance location or inlet 129 of the ejector shroud 128. The height-to-width ratio of the lobe channels will be between 0.5 and 4.5. The mixer penetration will be between 50% and 80%. The center body 103 plug trailing edge angles will be thirty degrees or less. The length to diameter (L/D) of the overall MEWT 100 will be between 0.5 and 1.25.

First-principles-based theoretical analysis of the preferred MEWT 100, performed by Applicants, indicate the MEWT can produce three or more times the power of its un-shrouded counterparts for the same frontal area; and, the MEWT 100 can increase the productivity of wind farms by a factor of two or more. Based on this theoretical analysis, it is believed the MEWT embodiment 100 will generate three times the existing power of the same size conventional open blade wind turbine.

A satisfactory embodiment 100 of the MEWT comprises: an axial flow turbine (e.g., stator vanes and impeller blades) surrounded by an aerodynamically contoured turbine shroud 102 incorporating mixing devices in its terminus region (i.e., end portion); and a separate ejector shroud 128 overlapping, but aft, of turbine shroud 102, which itself may incorporate mixer lobes in its terminus region. The ring 118 of mixer lobes 120a combined with the ejector shroud 128 can be thought of as a mixer/ejector pump. This mixer/ejector pump provides the means for consistently exceeding the Betz limit for operational efficiency of the wind turbine. The stator vanes' exit-angle incidence may be mechanically varied in situ (i.e., the vanes are pivoted) to accommodate variations in the fluid stream velocity so as to assure minimum residual swirl in the flow exiting the rotor.

Described differently, the MEWT 100 comprises a turbine stage 104 with a stator ring 106 and a rotor 110 mounted on center body 103, surrounded by turbine shroud 102 with embedded mixer lobes 120a having trailing edges inserted slightly in the entrance plane of ejector shroud 128. The turbine stage 104 and ejector shroud 128 are structurally connected to the turbine shroud 102, which is the principal load carrying member.

These figures depict a rotor/stator assembly for generating power. The term “impeller” is used herein to refer generally to any assembly in which blades are attached to a shaft and able to rotate, allowing for the generation of power or energy from wind rotating the blades. Exemplary impellers include a propeller or a rotor/stator assembly. Any type of impeller may be enclosed within the turbine shroud 102 in the wind turbine of the present disclosure.

In some embodiments, the length of the turbine shroud 102 is equal or less than the turbine shroud's outer maximum diameter. Also, the length of the ejector shroud 128 is equal or less than the ejector shroud's outer maximum diameter. The exterior surface of the center body 103 is aerodynamically contoured to minimize the effects of flow separation downstream of the MEWT 100. It may be configured to be longer or shorter than the turbine shroud 102 or the ejector shroud 128, or their combined lengths.

The turbine shroud's entrance area and exit area will be equal to or greater than that of the annulus occupied by the turbine stage 104, but need not be circular in shape so as to allow better control of the flow source and impact of its wake. The internal flow path cross-sectional area formed by the annulus between the center body 103 and the interior surface of the turbine shroud 102 is aerodynamically shaped to have a minimum area at the plane of the turbine and to otherwise vary smoothly from their respective entrance planes to their exit planes. The turbine and ejector shrouds' external surfaces are aerodynamically shaped to assist guiding the flow into the turbine shroud inlet, eliminating flow separation from their surfaces, and delivering smooth flow into the ejector entrance 129. The ejector 128 entrance area, which may alternatively be noncircular in shape, is greater than the mixer 118 exit plane area; and the ejector's exit area may also be noncircular in shape if desired.

Optional features of the preferred embodiment 100 can include: a power take-off, in the form of a wheel-like structure, which is mechanically linked at an outer rim of the impeller to a power generator; a vertical support shaft with a rotatable coupling for rotatably supporting the MEWT, the shaft being located forward of the center-of-pressure location on the MEWT for self-aligning the MEWT; and a self-moving vertical stabilizer fin or “wing-tab” affixed to upper and lower surfaces of the ejector shroud to stabilize alignment directions with different wind streams.

The MEWT 100, when used near residences can have sound absorbing material affixed to the inner surface of its shrouds 102, 128 to absorb and thus eliminate the relatively high frequency sound waves produced by the interaction of the stator 106 wakes with the rotor 110. The MEWT 100 can also contain blade containment structures for added safety. The MEWT should be considered to be a horizontal axis wind turbine as well.

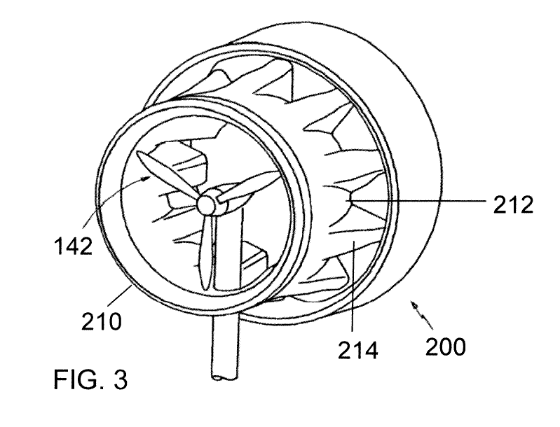

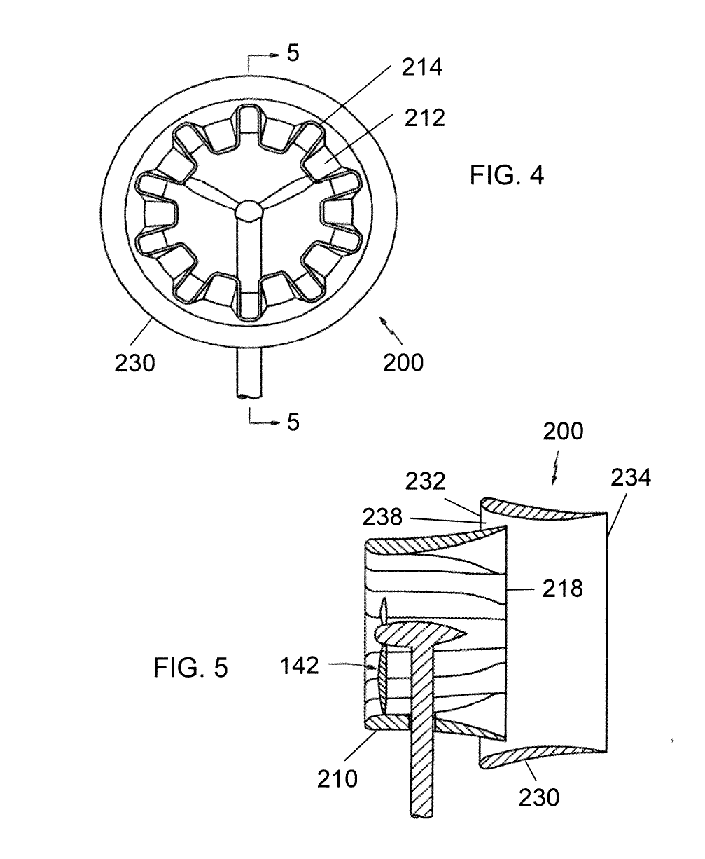

FIGS. 3-5 show a second exemplary embodiment of a shrouded wind turbine 200. The turbine 200 uses a propeller-type impeller 142 instead of the rotor/stator assembly as in FIG. 1 and FIG. 2. In addition, the mixing lobes can be more clearly seen in this embodiment. The turbine shroud 210 has two different sets of mixing lobes. Referring to FIG. 3 and FIG. 4, the turbine shroud 210 has a set of high energy mixing lobes 212 that extend inwards toward the central axis of the turbine. In this embodiment, the turbine shroud is shown as having 10 high energy mixing lobes. The turbine shroud also has a set of low energy mixing lobes 214 that extend outwards away from the central axis. Again, the turbine shroud 210 is shown with 10 low energy mixing lobes. The high energy mixing lobes alternate with the low energy mixing lobes around the trailing edge of the turbine shroud 210. From the rear, as seen in FIG. 4, the trailing edge of the turbine shroud may be considered as having a circular crenellated shape. The term “crenellated” or “castellated” refers to this general up-and-down or in-and-out shape of the trailing edge.

As seen in FIG. 5, the entrance area 232 of the ejector shroud 230 is larger than the exit area 234 of the ejector shroud. It will be understood that the entrance area refers to the entire mouth of the ejector shroud and not the annular area of the ejector shroud between the ejector shroud 230 and the turbine shroud 210. However, as seen further herein, the entrance area of the ejector shroud may also be smaller than the exit area 234 of the ejector shroud. As expected, the entrance area 232 of the ejector shroud 230 is larger than the exit area 218 of the turbine shroud 210, in order to accommodate the mixing lobes and to create an annular area 238 between the turbine shroud and the ejector shroud through which high energy air can enter the ejector.

The mixer-ejector design concepts described herein can significantly enhance fluid dynamic performance. These mixer-ejector systems provide numerous advantages over conventional systems, such as: shorter ejector lengths; increased mass flow into and through the system; lower sensitivity to inlet flow blockage and/or misalignment with the principal flow direction; reduced aerodynamic noise; added thrust; and increased suction pressure at the primary exit.

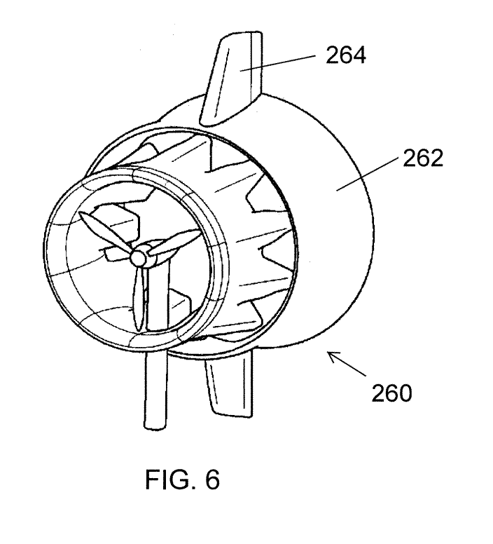

As shown in FIG. 6, another exemplary embodiment of a wind turbine 260 may have an ejector shroud 262 that has internal ribs shaped to provide wing-tabs or fins 264. The wing-tabs or fins 264 are oriented to facilitate alignment of the wind turbine 260 with the incoming wind flow to improve energy or power production.

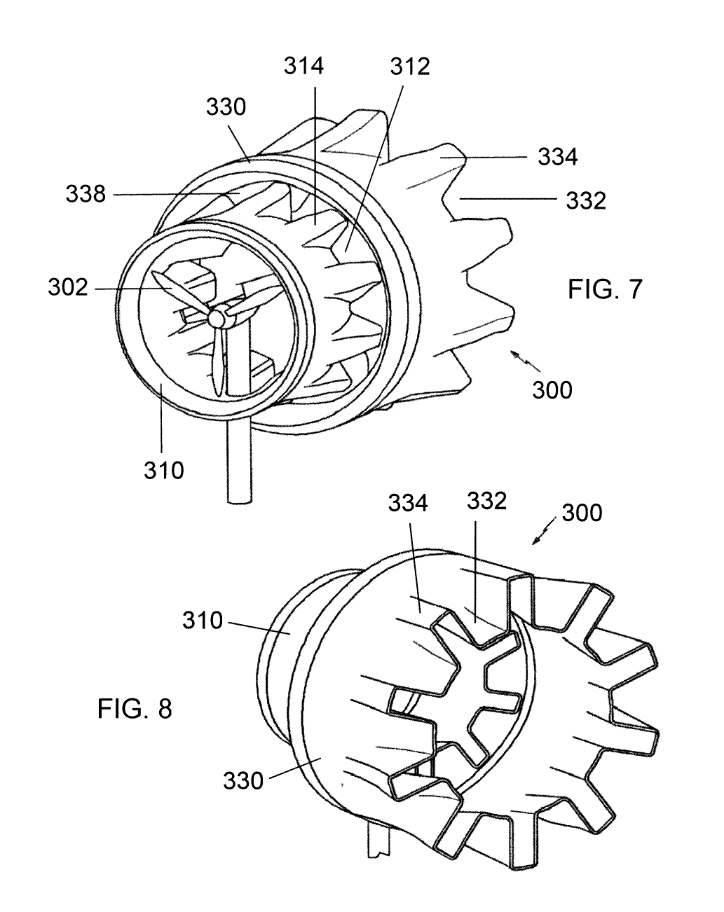

FIG. 7 and FIG. 8 illustrate another exemplary embodiment of a MEWT. The turbine 400 again uses a propeller-type impeller 302. The turbine shroud 310 has two different sets of mixing lobes. A set of high energy mixing lobes 312 extend inwards toward the central axis of the turbine. A set of low energy mixing lobes 314 extend outwards away from the central axis. In addition, the ejector shroud 330 is provided with mixing lobes on a trailing edge thereof. Again, two different sets of mixing lobes are present. A set of high energy mixing lobes 332 extend inwards toward the central axis of the turbine. A set of low energy mixing lobes 334 extend outwards away from the central axis. As seen in FIG. 8, the ejector shroud is shown here with 10 high energy mixing lobes and 10 low energy mixing lobes. The high energy mixing lobes alternate with the low energy mixing lobes around the trailing edge of the turbine shroud 330. Again, the trailing edge of the ejector shroud may be considered as having a circular crenellated shape.

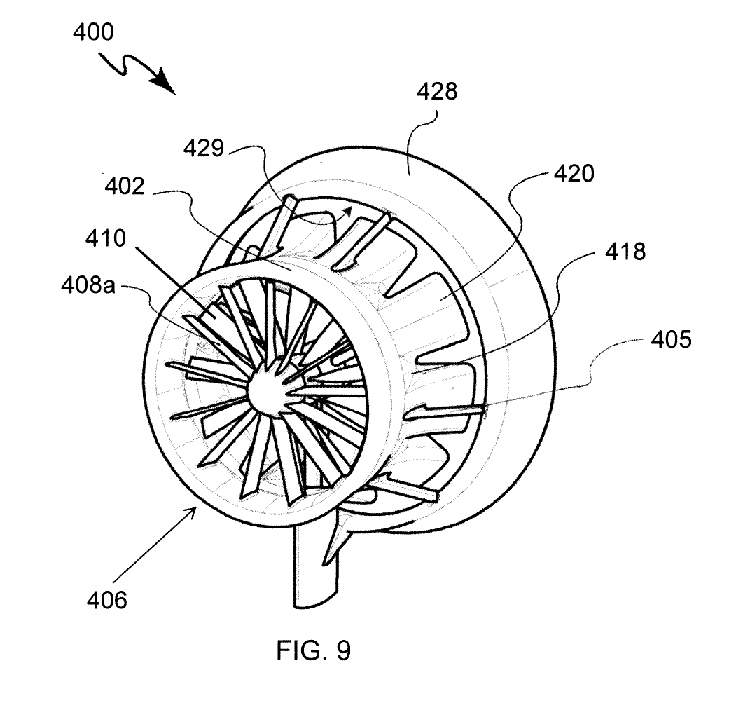

FIGS. 9-11 illustrate another exemplary embodiment of a MEWT. The MEWT 400 in FIG. 9 has a stator 408a and rotor 410 configuration for power extraction. A turbine shroud 402 surrounds the rotor 410 and is supported by or connected to the blades or spokes of the stator 408a. The turbine shroud 402 has the cross-sectional shape of an airfoil with the suction side (i.e. low pressure side) on the interior of the shroud. An ejector shroud 428 is coaxial with the turbine shroud 402 and is supported by connector members 405 extending between the two shrouds. An annular area is thus formed between the two shrouds. The rear or downstream end of the turbine shroud 402 is shaped to form two different sets of mixing lobes 418, 420. High energy mixing lobes 418 extend inwardly towards the central axis of the mixer shroud 402; and low energy mixing lobes 420 extend outwardly away from the central axis.

Free stream air indicated generally by arrow 406 passing through the stator 408a has its energy extracted by the rotor 410. High energy air indicated by arrow 429 bypasses the shroud 402 and stator 408a and flows over the turbine shroud 402 and directed inwardly by the high energy mixing lobes 418. The low energy mixing lobes 420 cause the low energy air exiting downstream from the rotor 410 to be mixed with the high energy air 429.

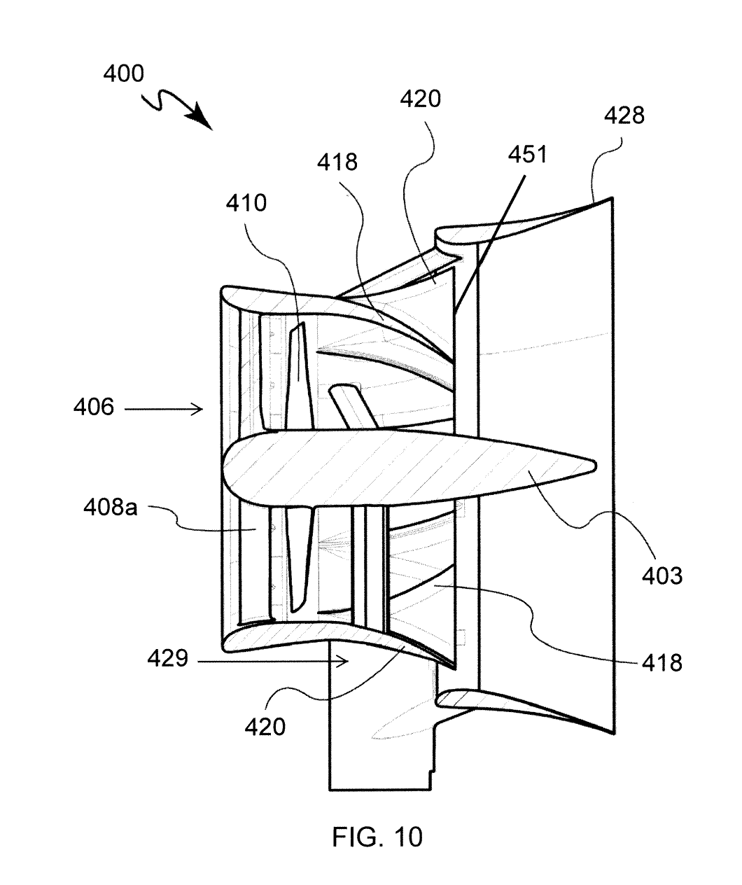

Referring to FIG. 10, the center nacelle 403 and the trailing edges of the low energy mixing lobes 420 and the trailing edge of the high energy mixing lobes 418 are shown in the axial cross-sectional view of the turbine of FIG. 9. The ejector shroud 428 is used to direct inwardly or draw in the high energy air 429. Optionally, nacelle 403 may be formed with a central axial passage therethrough to reduce the mass of the nacelle and to provide additional high energy turbine bypass flow.

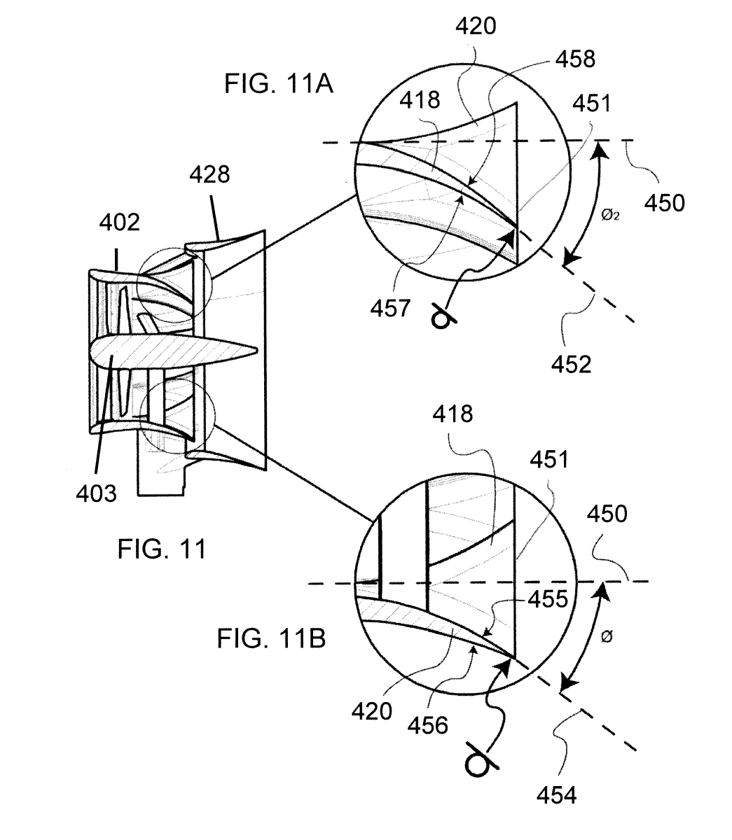

In FIG. 11A, a tangent line 452 is drawn along the interior trailing edge indicated generally at 457 of the high energy mixing lobe 418. A rear plane 451 of the turbine shroud 402 is present. A line 450 is formed normal to the rear plane 451 and tangent to the point where a low energy mixing lobe 420 and a high energy mixing lobe 418 meet. An angle Ø₂ is formed by the intersection of tangent line 452 and line 450. This angle Ø₂ is between 5 and 65 degrees. Put another way, a high energy mixing lobe 418 forms an angle Ø₂ between 5 and 65 degrees relative to the turbine shroud 402.

In FIG. 11B, a tangent line 454 is drawn along the interior trailing edge indicated generally at 455 of the low energy mixing lobe 420. An angle Ø is formed by the intersection of tangent line 454 and line 450. This angle Ø is between 5 and 65 degrees. Put another way, a low energy mixing lobe 420 forms an angle Ø between 5 and 65 degrees relative to the turbine shroud 402.

The shrouded wind turbines disclosed above show a turbine shroud having mixing lobes. Some embodiments also include an ejector shroud having mixing lobes. Such shrouds having mixing lobes can be assembled from a plurality of wind turbine segments, with each wind turbine segment being a fractional portion of the overall wind turbine shroud. The wind turbine shroud is formed by assembling a plurality of wind turbine shroud segments around a central axis. One advantage of this form is that the wind turbine shroud segments can be more easily transported than the overall assembled shroud. In addition, interior portions of shroud segments can be made hollow as desired, so that the weight of the overall shroud can be reduced. Wind turbine shroud segments and shrouds assembled from such shroud segments are further discussed herein.

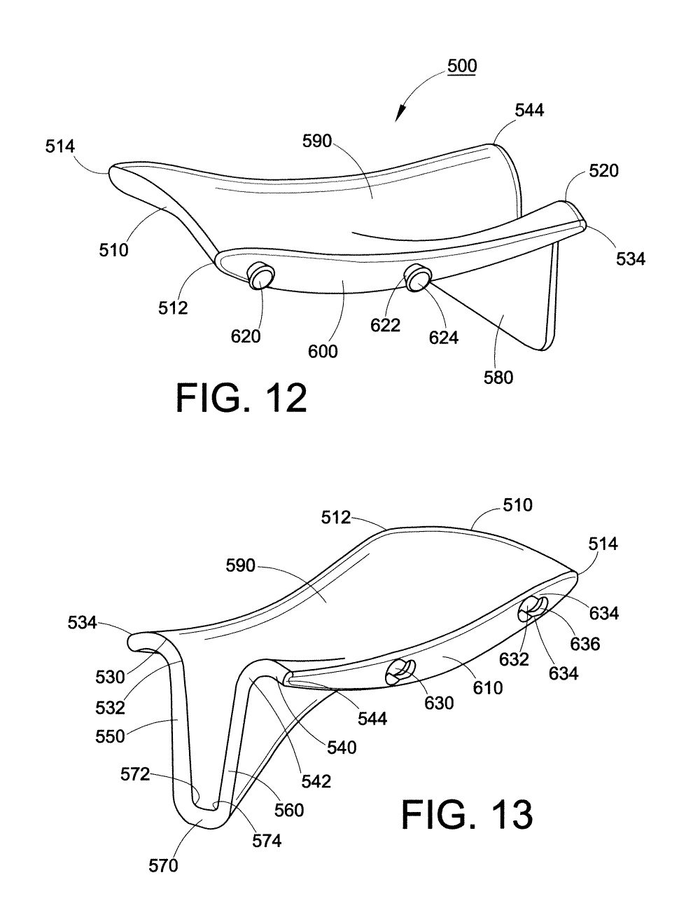

FIG. 12 and FIG. 13 illustrate an exemplary embodiment of a wind turbine shroud segment 500. The wind turbine shroud segment 500 may be hollow or solid. In some desired embodiments, the wind turbine shroud segment 500 is hollow. FIG. 12 is a front perspective. FIG. 13 is a rear perspective view.

The wind turbine shroud segment 500 has an arcuate front edge 510 and a rear edge 520. The term “edge” should not be construed herein as referring to a two-dimensional line. As seen here, the front edge 510 and the rear edge 520 are rounded. The front edge 510 has a first end 512 and a second end 514.

The rear edge 520 can be considered as including a first outer edge 530, a second outer edge 540, a first radial edge 550, a second radial edge 560, and an inner edge 570. The first outer edge 530 and the second outer edge 540 are located in an outer plane. As will be shown later, that outer plane may appear to be generally cylindrical depending on the perspective. The inner edge 570 is located in an inner plane, which may also appear to be generally cylindrical depending on the perspective. The first outer edge 530 has an interior end 532 and an exterior end 534. Similarly, the second outer edge 540 has an interior end 542 and an exterior end 544. In particular embodiments, the first outer edge and the second outer edge are of substantially the same length. The distance between the first outer edge interior end 532 and the second outer edge interior end 542 is less than the distance between the first outer edge exterior end 534 and the second outer edge exterior end 544.

The first radial edge 550 extends from a first end 572 of the inner edge 570 to the interior end 532 of the first outer edge 530. Similarly, the second radial edge 560 extends from a second end 574 of the inner edge 570 to the interior end 542 of the second outer edge 540. The surfaces where these edges join each other can be considered to be rounded surfaces. The resulting rear edge 520 could be described as having a partial castellated or crenellated shape, or as having a shape similar to a capital letter V when written in cursive D'Nealian script.

An interior face 580 extends from the front edge 510 to the rear edge 520. An exterior face 590 also extends from the front edge 510 to the rear edge 520. As will be explained further herein, the interior face forms the interior of the resulting wind turbine shroud. Put another way, the interior face is on the low suction side of the shroud, and is closer to the impeller than the exterior face.

A first lateral face 600 extends from the exterior end 534 of the first outer edge 530 to the first end 512 of the front edge 510. Likewise, a second lateral face 610 extends from the exterior end 544 of the second outer edge 540 to the second end 514 of the front edge 510. As shown here, the first lateral face 600 and the second lateral face 610 have an airfoil shape.

At least one protrusion 620 is present on the first lateral face 600 and extends away from the first lateral face. At least one cavity 630 is present on the second lateral face 610. Generally, there are a plurality of protrusions and cavities. Usually, the number of protrusions is equal to the number of cavities. The protrusion 620 and the cavity 630 are substantially complementary in shape so that adjacent shroud segments can engage each other. The protrusion is a male member, the cavity is a female member, and they form an engaging relationship. As shown here, the protrusion 620 includes a stem 622 and a head 624. The cavity 630 includes a keyhole 632 on one side of the cavity. The other cavity has two lips 634 which form a slot 636. The head 624 of the protrusion 620 is inserted into the keyhold 632, then moved laterally into the slot 636 to engage the two lips 634. The two lips prevent the head 624 from moving longitudinally or radially, thus maintaining the engagement between two adjacent wind turbine shroud segments.

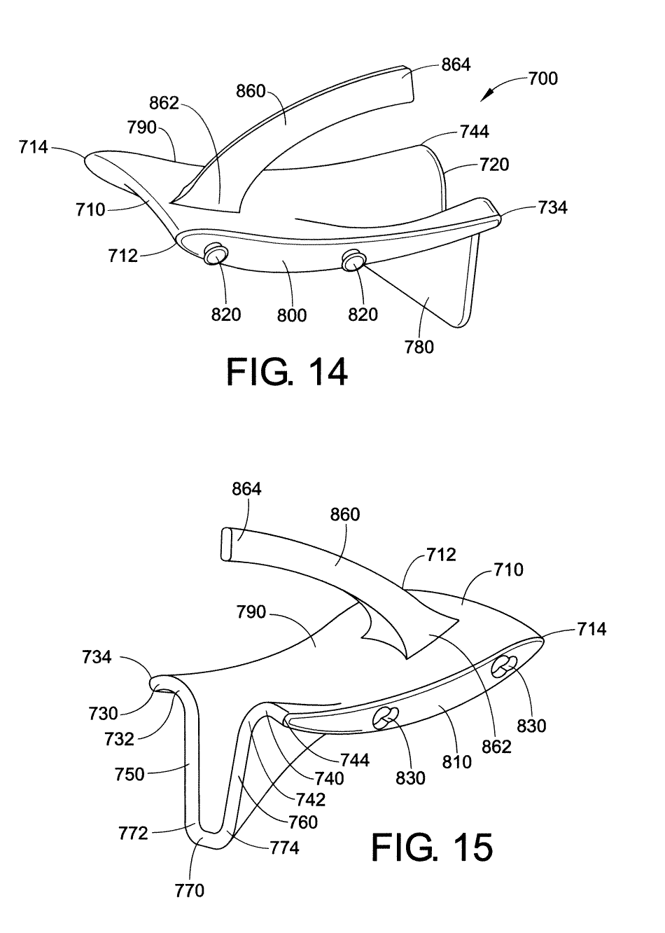

FIG. 14 and FIG. 15 illustrate another exemplary embodiment of a wind turbine shroud segment 700. FIG. 14 is a front perspective view, and FIG. 15 is a rear perspective view.

The wind turbine shroud segment 700 has an arcuate front edge 710 and a rear edge 720. As seen here, the front edge 710 and the rear edge 720 are rounded. The front edge 710 has a first end 712 and a second end 714.

The rear edge 720 comprises a first outer edge 730, a second outer edge 740, a first radial edge 750, a second radial edge 760, and an inner edge 770. The first outer edge 730 and the second outer edge 740 are located in an outer plane. The inner edge 770 is located in an inner plane. The first outer edge 730 has an interior end 732 and an exterior end 734. Similarly, the second outer edge 740 has an interior end 742 and an exterior end 744. The first radial edge 750 extends from a first end 772 of the inner edge 770 to the interior end 732 of the first outer edge 730. Similarly, the second radial edge 760 extends from a second end 774 of the inner edge 770 to the interior end 742 of the second outer edge 740.

An interior face 780 extends from the front edge 710 to the rear edge 720. An exterior face 790 also extends from the front edge 710 to the rear edge 720. A first lateral face 800 extends from the exterior end 734 of the first outer edge 730 to the first end 712 of the front edge 710. Likewise, a second lateral face 810 extends from the exterior end 744 of the second outer edge 740 to the second end 714 of the front edge 710. A plurality of protrusions 820 is present on the first lateral face 800. A plurality of cavities 830 is present on the second lateral face 810. The protrusions 820 and the cavities 830 are substantially complementary in shape so that adjacent shroud segments can engage each other.

The shroud segment of FIG. 14 differs from the shroud segment of FIG. 12 by including a support member 860. The support member 860 extends vertically from the exterior face 790. The vertical direction may also be considered a radial direction, relative to a central axis. Put another way, a first end 862 of the support member 860 is on the exterior face 790, and a second end 864 of the support member 860 is spaced apart from the exterior face 790. Described in yet another way, the support member 860 extends from the shroud segment such that the outer edges 730, 740 of the rear face 720 are between the second end 864 of the support member and the inner edge 770 of the rear face. The support member may also extend laterally in the direction of the rear edge 720 of the shroud segment 700.

The support member 860 may be located closer to one of the lateral faces than the other lateral face. In such embodiments, the first outer edge and the second outer edge are not of equal lengths. For example, if the support member is located closer to the first lateral face, the first outer edge will usually be longer than the second outer edge.

It is contemplated that the support member 860 can be formed as an integral part of the wind turbine shroud segment 700, or that the support member could be a separate part which is joined to the shroud segment. Depending on structural requirements, the support member 860 can be solid or hollow, independently of the construction of the rest of the shroud segment. It is also contemplated that the support member can be made of a different material from the shroud segment. For example, as discussed further herein, the support member could be a metal rod while the shroud segment is a plastic material.

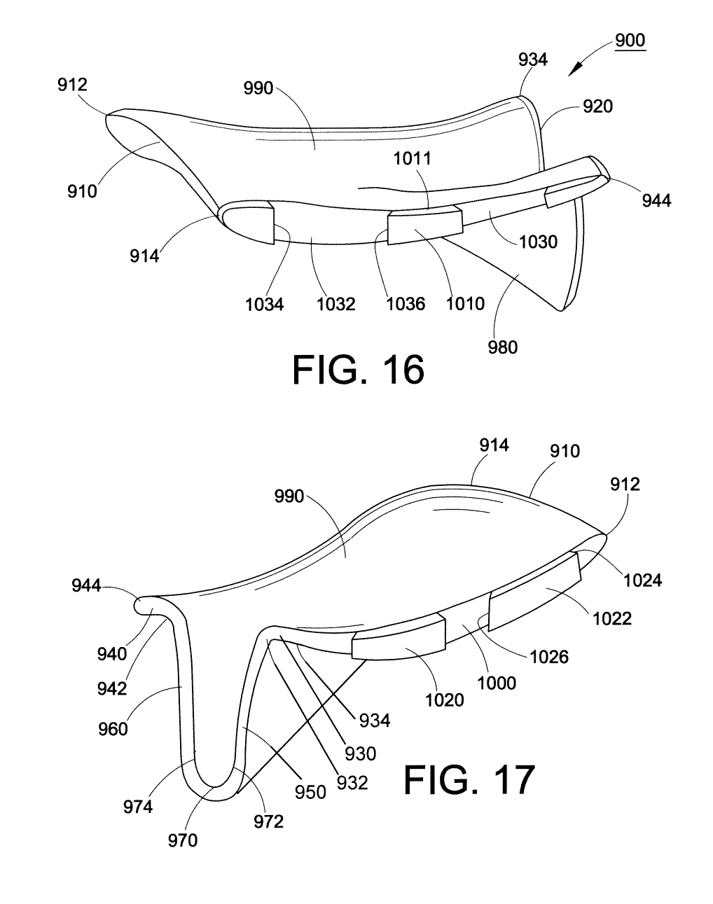

FIG. 16 and FIG. 17 illustrate another exemplary embodiment of a wind turbine shroud segment 900. FIG. 16 is a front perspective view, and FIG. 17 is a rear perspective view.

The wind turbine shroud segment 900 has an arcuate front edge 910 and a rear edge 920. As seen here, the front edge 910 and the rear edge 920 are rounded. The front edge 910 has a first end 912 and a second end 914.

The rear edge 920 comprises a first outer edge 930, a second outer edge 940, a first radial edge 950, a second radial edge 960, and an inner edge 970. The first outer edge 930 and the second outer edge 940 are located in an outer plane. The inner edge 970 is located in an inner plane. The first outer edge 930 has an interior end 932 and an exterior end 934. Similarly, the second outer edge 940 has an interior end 942 and an exterior end 944. The first radial edge 950 extends from a first end 972 of the inner edge 970 to the interior end 932 of the first outer edge 930. Similarly, the second radial edge 960 extends from a second end 974 of the inner edge 970 to the interior end 942 of the second outer edge 940.

An interior face 980 extends from the front edge 910 to the rear edge 920. An exterior face 990 also extends from the front edge 910 to the rear edge 920. A first lateral face 1000 extends from the exterior end 934 of the first outer edge 930 to the first end 912 of the front edge 910. Likewise, a second lateral face 1010 extends from the exterior end 944 of the second outer edge 940 to the second end 914 of the front edge 910. At least one protrusion 1020 is present on the first lateral face 1000. Here, two protrusions are shown. At least one cavity 1030 is present on the second lateral face 1010. Here, two cavities are shown. The protrusion(s) 1020 and the cavity(ies) 1030 are substantially complementary in shape so that adjacent shroud segments can engage each other.

The shroud segment of FIG. 16 differs from the shroud segments of FIG. 12 and FIG. 14 in the structure of the protrusion 1020 and the cavity 1030. In this embodiment, the first outer edge 930 and the second outer edge 940 are not of the same length. However, the distance between the first outer edge interior end 932 and the second outer edge interior end 942 is still less than the distance between the first outer edge exterior end 934 and the second outer edge exterior end 944.

As seen in FIG. 17, the protrusion 1020 includes an outer face 1022 spaced apart from the first lateral face 1000. A first protrusion side face 1024 and a second protrusion side face 1026 join the outer face 1022 to the first lateral face 1000. The outer face 1022 is beyond the first outer edge exterior end 934 of the rear edge 920. In other words, the protrusion 1020 extends away from the first lateral face 1000.

As seen in FIG. 16, the cavity 1030 includes an inner face 1032 spaced apart from the second lateral face 1010. A first cavity side face 1034 and a second cavity side face 1036 join the outer face 1032 to the second lateral face 1010. The outer face 1032 is within the second outer edge exterior end 944 of the rear edge 920. Put another way, the outer face 1032 is located between the first lateral face 1000 and the second lateral face 1010. In other words, the cavity 1030 extends into the second lateral face 1010. It should also be noted that the cavity is not located near the front edge 910 or the rear edge 920, but is located in a central portion 1011 of the second lateral face 1010.

The side faces 1024, 1026 of the protrusion 1020 and the side faces 1034, 1036 of the cavity 1030 are shaped so that the protrusion and cavity of adjacent shroud segments are engaged in a radial direction. In addition, the side faces are shaped so that engagement occurs in one radial direction, while disengagement occurs in the opposite radial direction.

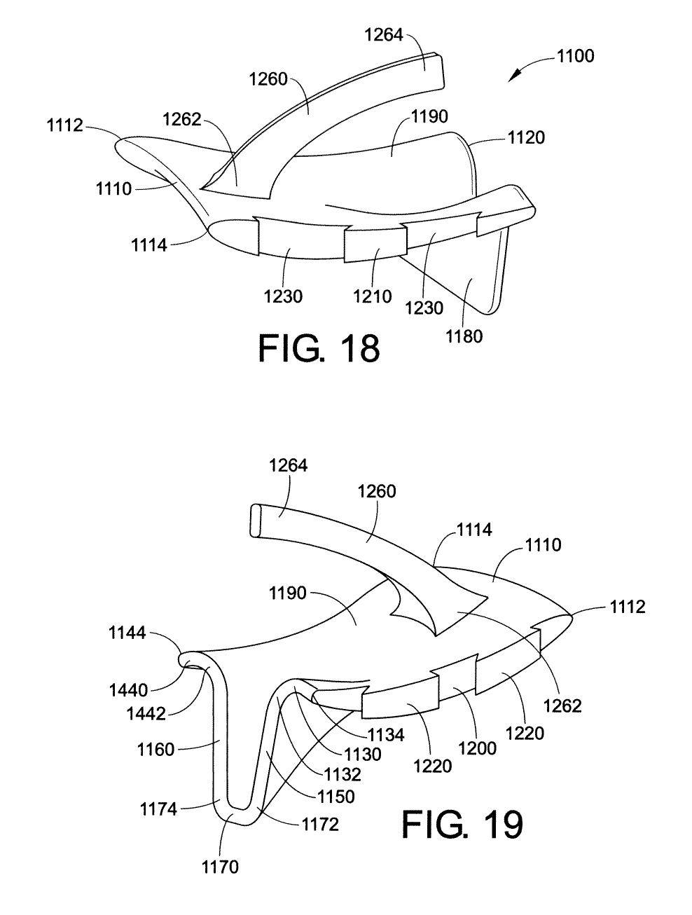

FIG. 18 and FIG. 19 illustrate another exemplary embodiment of a wind turbine shroud segment 1100. FIG. 16 is a front perspective view, and FIG. 17 is a rear perspective view.

The wind turbine shroud segment 1100 has an arcuate front edge 1110 and a rear edge 1120. As seen here, the front edge 1110 and the rear edge 1120 are rounded. The front edge 1110 has a first end 1112 and a second end 1114.

The rear edge 1120 comprises a first outer edge 1130, a second outer edge 1140, a first radial edge 1150, a second radial edge 1160, and an inner edge 1170. The first outer edge 1130 and the second outer edge 1140 are located in an outer plane. The inner edge 1170 is located in an inner plane. The first outer edge 1130 has an interior end 1132 and an exterior end 1134. Similarly, the second outer edge 1140 has an interior end 1142 and an exterior end 1144. The first radial edge 1150 extends from a first end 1172 of the inner edge 1170 to the interior end 1132 of the first outer edge 1130. Similarly, the second radial edge 1160 extends from a second end 1174 of the inner edge 1170 to the interior end 1142 of the second outer edge 1140.

An interior face 1180 extends from the front edge 1110 to the rear edge 1120. An exterior face 1190 also extends from the front edge 1110 to the rear edge 1120. A first lateral face 1200 extends from the exterior end 1134 of the first outer edge 1130 to the first end 1112 of the front edge 1110. Likewise, a second lateral face 1210 extends from the exterior end 1144 of the second outer edge 1140 to the second end 1114 of the front edge 1110. At least one protrusion 1220 is present on the first lateral face 1200. At least one cavity 1230 is present on the second lateral face 1210. The protrusion 1220 and the cavity 1230 are substantially complementary in shape so that adjacent shroud segments can engage each other.

The protrusion 1220 and cavity 1230 in this embodiment are similar to those shown in FIG. 16. In addition, a support member 1260 is present. The support member 1260 extends radially from the exterior face 1190. Put another way, a first end 1262 of the support member 1260 is on the exterior face 1190, and a second end 1264 of the support member 1260 is spaced apart from the exterior face 1190. The support member may also extend laterally in the direction of the rear edge 1120 of the shroud segment 1100.

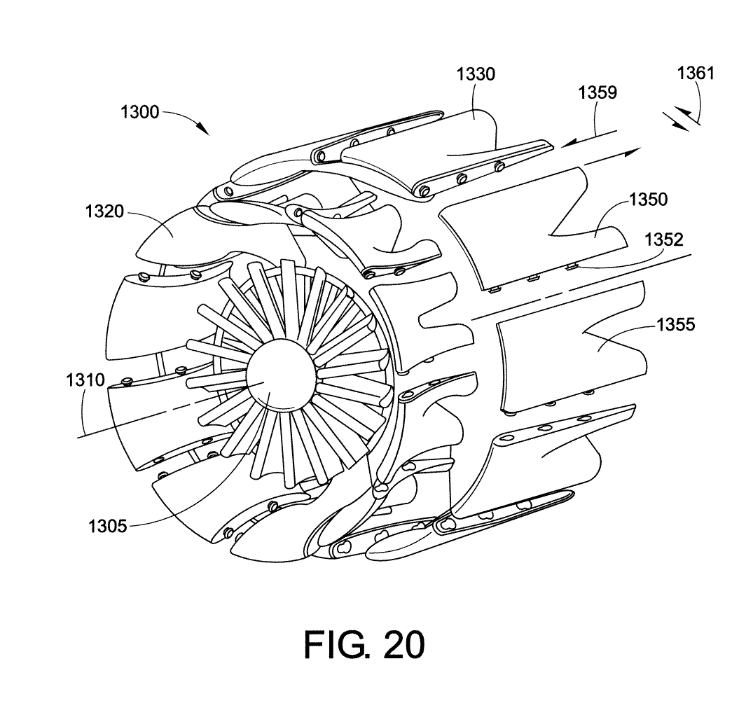

FIG. 20 illustrates how the wind turbine shroud segments described above can be assembled to form a wind turbine shroud. This is an exploded view of the wind turbine 1300 prior to engagement of the shroud segments. An impeller 1305 is positioned along a central axis 1310, which is the central axis of the wind turbine. A first set of wind turbine shroud segments 1320 is positioned around the central axis. When engaged together, this first set of shroud segments 1320 will form a turbine shroud 1325. A second set of wind turbine shroud segments 1330 is also positioned around the central axis. When engaged together, this second set of shroud segments 1330 will form an ejector shroud 1335.

Both sets of shroud segments 1320, 1330 shown here are similar to that shown in FIG. 12 and FIG. 13. Shroud segment 1350 includes a protrusion 1352, while shroud segment 1355 includes a cavity (not visible). The two shroud segments are engaged by inserting protrusion 1352 longitudinally into the cavity, then moving the two shroud segments laterally with respect to each other. The longitudinal direction is indicated by arrow 1361. The lateral direction is indicated by arrow 1359, and can also be considered an axial direction relative to the central axis 1310.

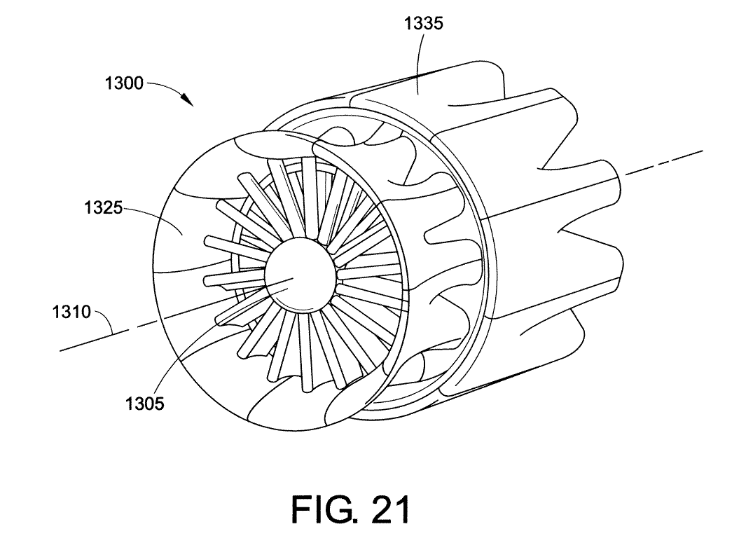

FIG. 21 shows the wind turbine of FIG. 20 in an assembled state. The impeller 1305, turbine shroud 1325, and ejector shroud 1335 are coaxial around the axis 1310. The ejector shroud 1335 is located downstream of the turbine shroud 1335.

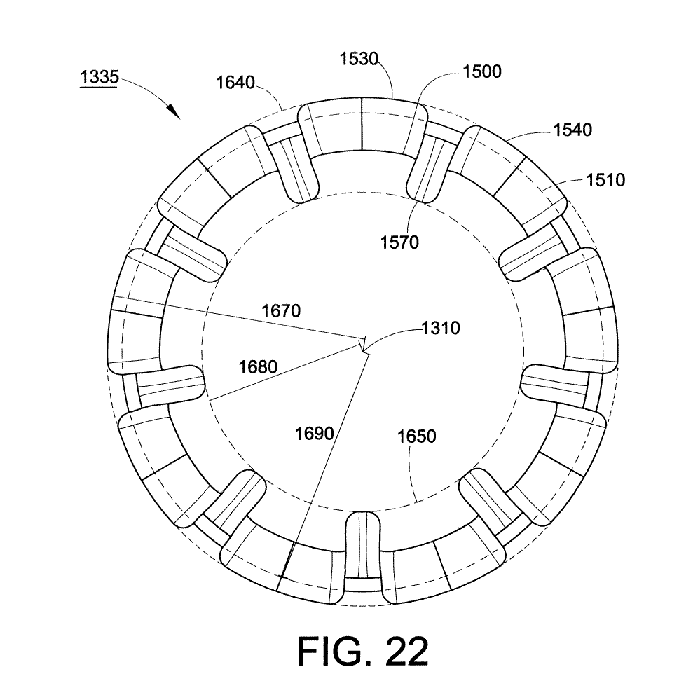

FIG. 22 is a rear view of the assembled ejector shroud 1335 of FIG. 21, and illustrates some additional aspects of the wind turbine shroud segment. Referring to wind turbine shroud segment 1500, the first outer edge 1530, the second outer edge 1540, and the inner edge 1570 are visible. The first outer edge 1530 and the second outer edge 1540 are located in an outer plane, which is indicated here with reference numeral 1640. The inner edge 1570 is located in an inner plane indicated here with reference numeral 1650. As seen from this perspective, the outer plane 1640 and inner plane 1650 are generally cylindrical, with their axis being the central axis 1310. The outer plane 1640 and inner plane 1650 are also coaxial.

In addition, the first outer edge 1530 and the second outer edge 1540 of the shroud segment 1500 can be considered as having a common outer radius of curvature 1670. The term “common” is used here to mean that the first outer edge and the second outer edge have the same radius of curvature. Similarly, the inner edge 1570 has an inner radius of curvature 1680. The front edge (not visible) of the shroud segment 1500, indicated here as dotted circle 1510, has a front radius of curvature 1690. The outer radius of curvature 1670 of the shroud segment is greater than the inner radius of curvature 1680. The front radius of curvature 1690 of the shroud segment 1500 can be greater than, substantially equal to, or less than the outer radius of curvature 1670.

In specific embodiments, the outer radius of curvature 1670 of the shroud segment is greater than the inner radius of curvature 1680, and the front radius of curvature 1690 of the shroud segment 1500 is also less than the outer radius of curvature 1670.

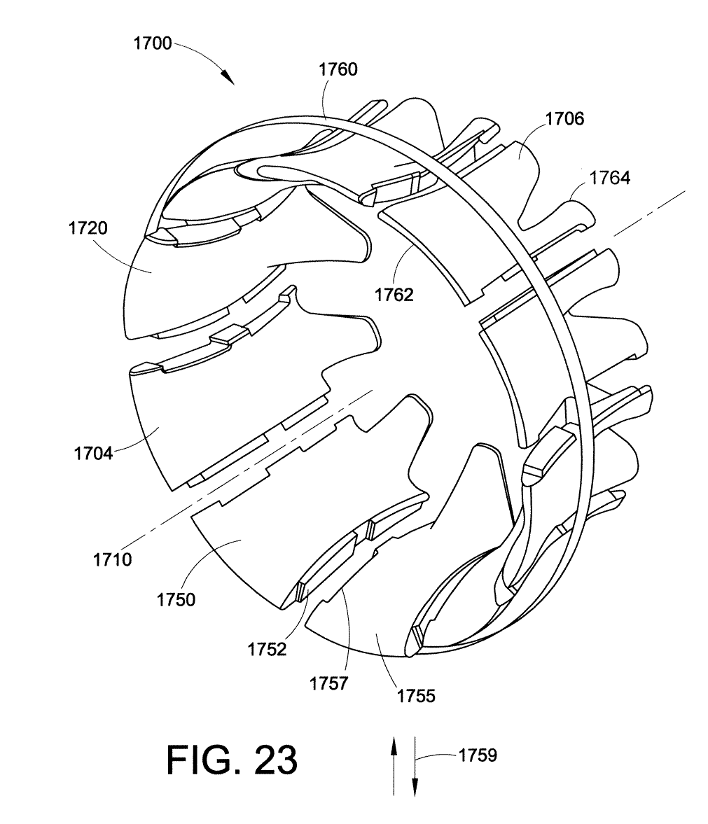

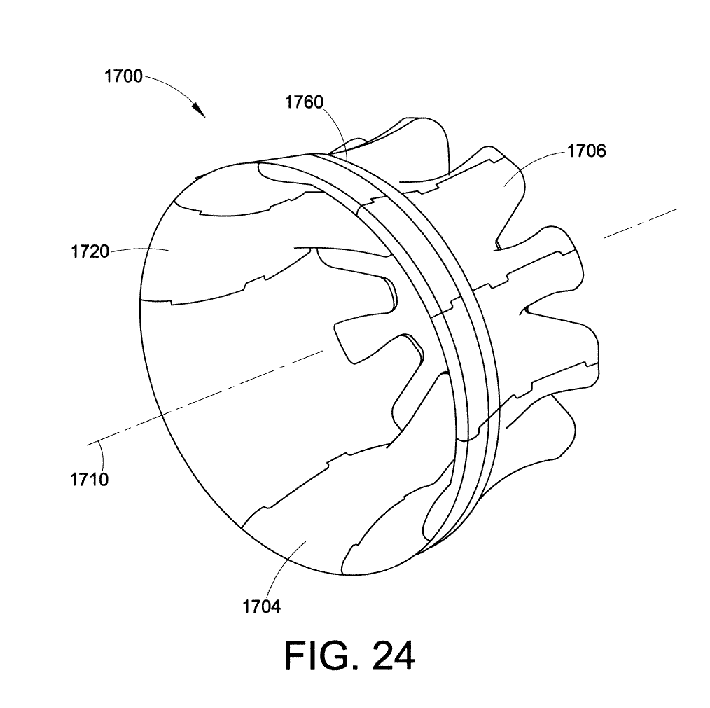

FIG. 23 is another figure illustrating how wind turbine shroud segments can be assembled to form a wind turbine shroud. This is an exploded view of the wind turbine shroud 1700 prior to engagement of the shroud segments. A first set of wind turbine shroud segments 1720 is positioned around the central axis 1710. The interior face of a shroud segment is indicated with reference numeral 1704, and the exterior face is indicated with reference numeral 1706.

The shroud segments 1720 shown here are similar to that shown in FIG. 16 and FIG. 17. Shroud segment 1750 includes a protrusion 1752, while shroud segment 1755 includes a cavity 1757. The two shroud segments are engaged by inserting protrusion 1752 into the cavity 1757 in a radial direction towards the central axis 1710. The radial direction is indicated by arrow 1759, and is relative to the central axis 1710. The two shroud segments would be disengaged, if desired, by moving removing the protrusion 1752 from the cavity 1757 in a radial direction away from the central axis 1710.

In addition, a ring member 1760 is shown here. When the shroud 1700 is assembled, the ring member engages the shroud segments 1720 and prevents them from disengaging, i.e. moving in the radial direction away from the central axis. The ring member is typically engaged between the front edge 1762 and the rear edge 1764 of the shroud segment 1720. It is contemplated that the ring member 1760 may be flexible, and may act, for example, like a belt that is cinched around the shroud segments 1720.

FIG. 24 shows the wind turbine shroud 1700 of FIG. 23 in an assembled state. The shroud segments 1720 are arranged in a radial pattern around the central axis 1710. The ring member 1760 is shown here engaging the shroud segments 1720 and retaining them in an engaged or assembled state. The ring member 1760 surrounds the shroud members 1720. Put another way, the ring member 1760 is disposed along the exterior faces 1706 of the shroud segments 1720.

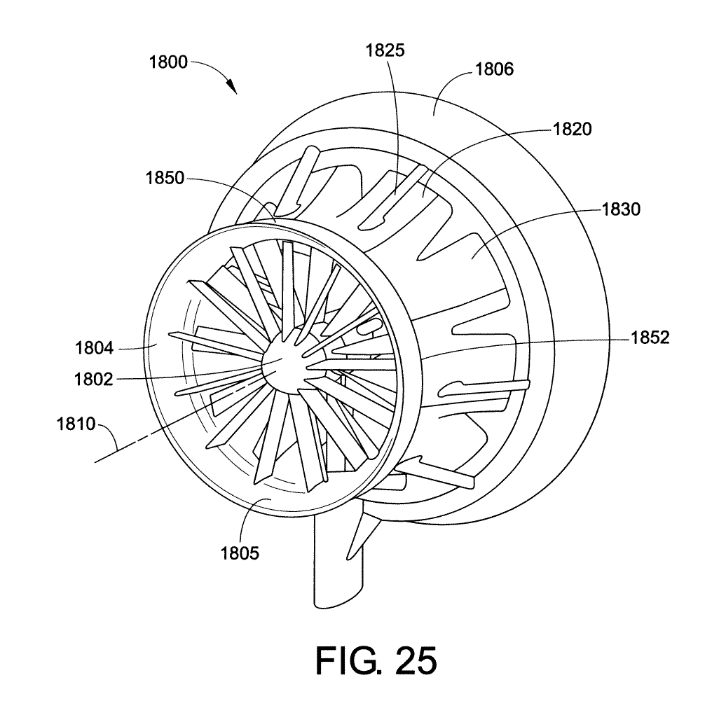

FIG. 25 shows another exemplary embodiment of a wind turbine 1800 that illustrates additional aspects of the present disclosure. As seen here, an impeller 1802, turbine shroud 1804, and ejector shroud 1806 are positioned along a central axis 1810.

Here, the turbine shroud 1804 is formed from a plurality of wind turbine shroud segments. The shroud segments can be divided into a set of first shroud segments 1820 and a set of second shroud segments 1830. The first shroud segments 1820 each have a support member 1825, and are similar to the embodiment of FIG. 14. The second shroud segments 1830 do not have a support member, and are similar to the embodiment of FIG. 12. It should be noted that in the shroud segments shown here, the first outer edge and the second outer edge will not be of the same length, and the support member 1825 is closer to one lateral face than the other.

In addition, the shroud segments 1820, 1830 are joined to a rear edge 1852 of a first structural member 1850. Here, the first structural member 1850 defines the leading edge 1805 of the turbine shroud 1804. The first structural member 1850 is generally circular, when viewed from the front along the central axis 1810. The first structural member 1850 provides a structure to support the impeller 1802 and also acts as a funnel to channel air through the impeller.

In embodiments that use a first structural member, the combination of the first structural member and the shroud segments form an airfoil shape. Put another way, the first and second lateral faces of the shroud segments in such embodiments do not necessarily themselves have an airfoil shape.

The wind turbine shroud segments described in the present disclosure can be made by molding. Generally, a molten plastic material is placed in a mold. The molten plastic material is then conformed to the mold to create a segment shape. This shape is then cooled and removed from the mold to obtain the wind turbine shroud segment.

Rotational molding and blow molding processes are contemplated by this disclosure. In rotational molding, the molten plastic material is conformed to the mold by rotating the mold biaxially. This biaxial rotation may be relatively slow and is usually about two perpendicular axes. Rotational molding is a high temperature, low pressure process, and may require longer cycle times. However, the longer cycle time is usually offset by production of a lower quantity of parts. Many products that are designed to withstand constant exposure to elements are manufactured with the rotational molding process.

Blow molding allows hollow plastic parts to be formed. Here, the molten plastic material that is placed in the mold initially has a tube-like shape, known as a parison or perform. The molten plastic material is conformed to the mold by injecting compressed air into the parison, forcing the plastic material against the sides of the mold cavity to form the desired shape. Some advantages of this process include continuous extrusion, and multi-layer coextrusion with up to seven layers in the finished part. Cycle times can also be shorter than rotational molding.

The plastic material used to make a wind turbine shroud segment is generally a polymer. In specific embodiments, the plastic material comprises a polyolefin or a polyamide. Exemplary polyolefins include polypropylene and polyethylene, such as high density polyethylene (HDPE) and low density polyethylene (LDPE). Exemplary polyamides include nylons. Polyvinyl chloride and plastisols may also be used.

The present disclosure has been described with reference to exemplary embodiments. Obviously, modifications and alterations will occur to others upon reading and understanding the preceding detailed description. It is intended that the present disclosure be construed as including all such modifications and alterations insofar as they come within the scope of the appended claims or the equivalents thereof.

1. A wind turbine shroud segment comprising:
a front edge having a first end and a second end;
a rear edge comprising:
a first outer edge and a second outer edge located in an outer plane;
an inner edge located in an inner plane and between the first and second outer edges;
a first radial edge extending from a first end of the inner edge to an interior end of the first outer edge; and
a second radial edge extending from a second end of the inner edge to an interior end of the second outer edge;
an interior face extending from the front edge to the rear edge;
an exterior face extending from the front edge to the rear edge;
a first lateral face extending from an exterior end of the first outer edge to the first end of the front edge; and
a second lateral face extending from an exterior end of the second outer edge to the second end of the front edge.

2. The wind turbine shroud segment of claim 1, wherein the front edge has an arcuate shape.

3. The wind turbine shroud segment of claim 1, wherein the first lateral face and the second lateral face each have an airfoil shape.

4. The wind turbine shroud segment of claim 1, wherein the first outer edge and the second outer edge have a common outer radius of curvature, the inner edge has an inner radius of curvature, and the front edge has a front radius of curvature;
the front radius of curvature is less than the outer radius of curvature; and
the inner radius of curvature is less than the outer radius of curvature.

5. The wind turbine shroud segment of claim 1, wherein the wind turbine shroud segment is hollow.

6. The wind turbine shroud segment of claim 1, wherein the first lateral face of the wind turbine shroud segment comprises a protrusion and the second lateral face of the wind turbine shroud segment comprises a cavity, the protrusion and the cavity being substantially complementary in shape so that adjacent shroud segments can engage each other.

7. The wind turbine shroud segment of claim 6, wherein the protrusion and the cavity are shaped so that adjacent shroud segments engage each other in a lateral direction.

8. The wind turbine shroud segment of claim 6, wherein the protrusion and the cavity are shaped so that adjacent shroud segments engage each other in a radial direction.

9. The wind turbine shroud segment of claim 1, further comprising a support member extending radially from the exterior face.

10. A method for making a wind turbine shroud segment, comprising:
placing a molten plastic material in a mold;
conforming the molten plastic material to the mold to create a segment shape;
cooling the segment shape; and
removing the segment shape from the mold to obtain the shroud segment;
wherein the shroud segment comprises:
a front edge having a first end and a second end;
a rear edge comprising:
a first outer edge and a second outer edge located in an outer plane;
an inner edge located in an inner plane and between the first and second outer edges;
a first radial edge extending from a first end of the inner edge to an interior end of the first outer edge; and
a second radial edge extending from a second end of the inner edge to an interior end of the first outer edge;
an interior face extending from the front edge to the rear edge;
an exterior face extending from the front edge to the rear edge;
a first lateral face extending from an exterior end of the first outer edge to the first end of the front edge; and
a second lateral face extending from an exterior end of the second outer edge to the second end of the front edge.

11. The method of claim 10, wherein conforming the plastic material to the mold is performed by rotating the mold biaxially.

12. The method of claim 10, wherein conforming the plastic material to the mold is performed by injecting compressed air into the molten plastic material to form a hollow interior space within the molten plastic material.

13. The method of claim 10, wherein the plastic material is a polymer.

14. The method of claim 13, wherein the plastic material is a polyolefin.

15. The method of claim 13, wherein the plastic material is a polyamide.

16. A wind turbine shroud comprising a plurality of wind turbine shroud segments;
wherein adjacent wind turbine shroud segments are engaged to each other in a radial pattern about a central axis; and
wherein each shroud segment comprises:
a front edge having a first end and a second end;
a rear edge comprising:
a first outer edge and a second outer edge located in an outer plane;
an inner edge located in an inner plane and between the first and second outer edges;
a first radial edge extending from a first end of the inner edge to an interior end of the first outer edge; and
a second radial edge extending from a second end of the inner edge to an interior end of the first outer edge;
an interior face extending from the front edge to the rear edge;
an exterior face extending from the front edge to the rear edge;
a first lateral face extending from an exterior end of the first outer edge to the first end of the front edge; and
a second lateral face extending from an exterior end of the second outer edge to the second end of the front edge.

17. The wind turbine shroud of claim 16, wherein the wind turbine shroud segments are hollow.

18. The wind turbine shroud of claim 16, wherein the wind turbine shroud further comprises a ring member surrounding the wind turbine shroud segments.

19. The wind turbine shroud of claim 16, further comprising a rigid structural member, the front edge of each shroud segment connecting to the rigid structural member.

20. The wind turbine shroud of claim 16, wherein the plurality of shroud segments includes a first set of shroud segments and a second set of shroud segments, the first set of shroud segments further comprising a support member extending vertically from the exterior face of each shroud segment.
